(19) United States
(12) Patent Application Publication
(10) Pub. No.: US 2010/0037649 A1
(43) Pub. Date: Feb. 18, 2010

(54) Refrigerant Filtering Device of Air-Conditioner

(75) Inventor: Jung Bong YU, Busan-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/323,856

(22) Filed: Nov. 26, 2008

(30) Foreign Application Priority Data
Aug. 14, 2008 (KR) 10-2008-0079975

(51) Int. Cl. F25B 43/00; B60H 1/32

(52) U.S. Cl. 62/474; 62/239

(57) ABSTRACT

A refrigerant filtering device of an air-conditioner includes a receiver drier having a communicating hole formed in the vicinity of a head pipe of a condenser so as to bypass refrigerant from the head pipe to the receiver drier, an insert member configured to be inserted into the communicating hole of the receiver drier, wherein a refrigerant inlet and a refrigerant outlet are formed at the insert member so that the receiver drier communicates with the head pipe, a wing member extending upwards in a bent shape from both lateral sides of the insert member to substantially receive the receiver drier, and/or a filter which is disposed at the refrigerant outlet inside the receiver drier to filter foreign substances contained in the refrigerant.

### CROSS-REFERENCE TO RELATED APPLICATION

The present application claims priority to Korean Patent Application No. 10-2008-0079975 filed on Aug. 14, 2008, the entire contents of which application is incorporated herein for all purposes by this reference.

### BACKGROUND OF THE INVENTION

1. Field of the Invention

The present invention relates to a refrigerant filtering device of an air-conditioner, and more particularly, to a refrigerant filtering device of an air-conditioner in which installation and exchange of a filter are convenient.

2. Description of Related Art

Generally, a condenser which is used to an air-conditioner for vehicles is a heat exchanger which performs heat exchange between gaseous refrigerant compressed at high temperature and high pressure supplied from a compressor and atmospheric air of relatively lower temperature so as to convert the gaseous refrigerant to liquefied refrigerant.

Such a condenser has a structure that requires a plurality of tubes and heat radiation fins disposed alternately between a pair of head pipes which are arranged to face each other.

One of the head pipes is provided with an inlet pipe and an outlet pipe so that refrigerant is supplied thereto and is discharged therefrom, and a receiver drier with a cylindrical shape is coupled to the other of the head pipes to communicate with the same, so that it is configured such that moisture and foreign substances contained in liquefied refrigerant can be removed.

The conventional refrigerant filtering device of an air-conditioner includes a receiver drier with a body having an inlet and an outlet providing a refrigerant flow passageway communicating with the one side head pipe and upper and lower caps closing an upper end portion and a lower end portion of the body, a drier which is provided inside the body and removes moisture contained in refrigerant, and a filter which is formed as a net so as to filter foreign substances contained in refrigerant supplied through the inlet.

In particular, the filter of the conventional refrigerant filtering device of an air-conditioner should be firmly fixed to an inner circumference surface of the body of the receiver drier so as to resist to the flow velocity of refrigerant.

Because of this, one of the upper and the lower caps of the receiver drier is inserted into the receiver drier and is coupled thereto in an opened state together with the filter and a plurality of fixing members, so that installation is not convenient.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a refrigerant filtering device of an air-conditioner in which a filter can be easily installed.

In an aspect of the present invention, a refrigerant filtering device of an air-conditioner, may include a receiver drier having a communicating hole formed in the vicinity of a head pipe of a condenser so as to bypass refrigerant from the head pipe to the receiver drier, an insert member configured to be inserted into the communicating hole of the receiver drier, wherein a refrigerant inlet and a refrigerant outlet are formed at the insert member so that the receiver drier communicates with the head pipe, a wing member extending upwards in a bent shape from both lateral sides of the insert member to substantially receive the receiver drier, and/or a filter which is disposed at the refrigerant outlet inside the receiver drier to filter foreign substances contained in the refrigerant.

The filter may have a hat shape.

The receiver drier may have a cylindrical shape.

A filter fixing plate may be attached to the filter so as to stably seat the filter to the refrigerant outlet. One end portion of the refrigerant outlet may be formed of a concave seating groove around an inner circumference thereof and an outer circumference of the filter fixing plate is inserted into the concave seating groove. At least one hook may be protruded from the inner circumference of the refrigerant outlet toward the seating groove so as to stably seat the filter to the refrigerant outlet. The hook may be formed as a [symbol] shape.

The filter fixing plate may be formed as a quadrilateral band shape.

Curvature of the inner portion of the wing member may be substantially the same as the curvature of the receiver drier.

The wing member may be welded to the insert member to receive an outer circumference of the receiver drier.

The refrigerant filtering device may further include an auxiliary wing member extending downwards in a bent shape from both lateral sides of the insert member.

Curvature of the inner portion of the auxiliary wing member may be substantially the same as the curvature of the head pipe.

The auxiliary wing member may be welded to the head pipe to receive an outer circumference of the head pipe.

The refrigerant filtering device may further include a pair of guide bars which are protruded in parallel on both upper sides of the insert member. A caulking may be configured to be placed on the respective guide bars so as to restrain the filter fixing plate. The guide bars may include a receiving notch and a caulking is configured to be placed on the respective notch so as to restrain the filter fixing plate.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of connection between a filter and flow passageway connecting conduit of a refrigerant filtering device of an air-conditioner according to an exemplary embodiment of the present invention.

FIG. 2 is a perspective view showing the state in which the filter and the flow passageway connecting conduit of FIG. 1 are assembled together.

FIG. 3 is a perspective view showing the partially cut away state in which the flow passageway connecting conduit of FIG. 2 in which the filer is installed is disposed to be welded between a receiver drier and one side head pipe.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Terms and words which are used in the specification and claims should not be definitely interpreted as general meanings or lexical meanings, but should be interpreted as meanings and concepts in conformity with the spirit of the present invention according to the principle that the inventor can adequately define the meaning of terms in order to explain the invention in a best way.

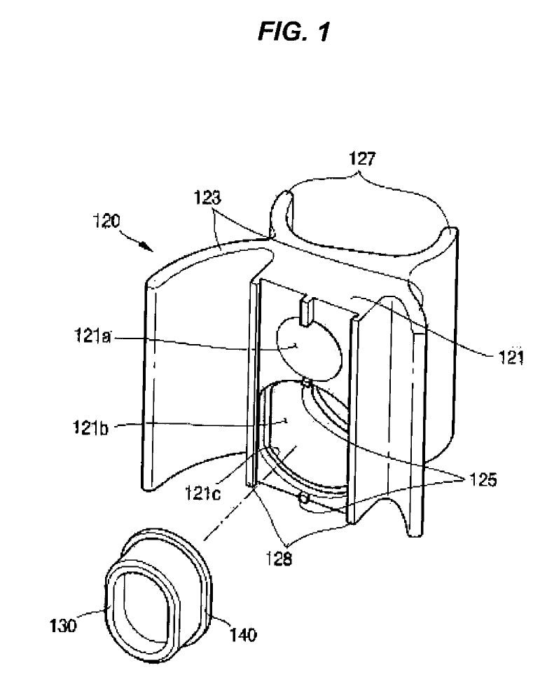

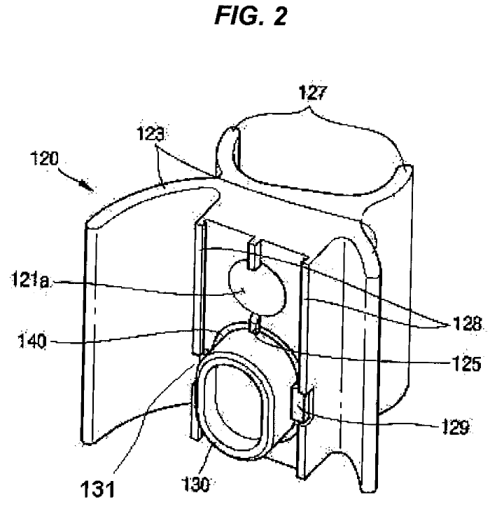

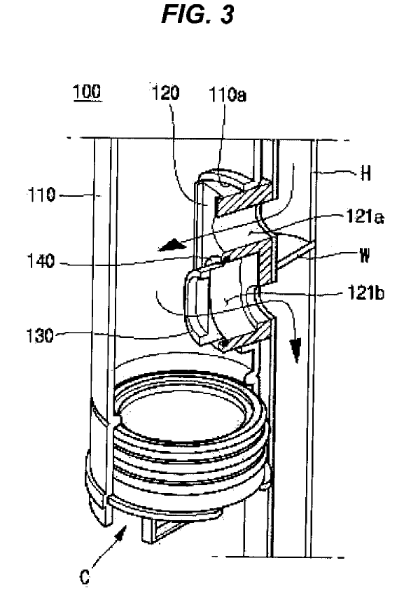

FIG. 1 is a perspective view of connection between a filter and flow passageway connecting conduit of a refrigerant filtering device of an air-conditioner according to various embodiments of the present invention, FIG. 2 is a perspective view showing the state in which the filter and the flow passageway connecting conduit of FIG. 1 are assembled together, and FIG. 3 is a perspective view showing the partially cut away state in which the flow passageway connecting conduit of FIG. 2 in which the filer is installed is disposed to be welded between a receiver drier and one side head pipe.

As shown in the drawings, a refrigerant filtering device 100 of an air-conditioner according to various exemplary embodiments of the present invention includes a condenser which is provided with a plurality of tubes and heat radiation fins which are alternately laminated between a pair of head pipes H so as to liquefy refrigerant of a gaseous state, a receiver drier 110 which communicates with the one side head pipe H to bypass refrigerant inside the condenser, a flow passageway connecting conduit 120 connecting the one side head pipe H and the receiver drier 110, a filter 130 which is disposed at a side of the flow passageway connecting conduit 120 to filter refrigerant and a filter fixing plate 140 to fix the filter 130.

The receiver drier 110 has a cylindrical shape, is provided with an upper and lower caps C so as to open and close an upper end portion and lower end portion, and is provided with a drier to remove moisture contained in refrigerant therein. In addition, the receiver drier 110 is provided with a communicating hole 110a which is formed as a quadrangle on an outer circumference surface neighboring and corresponding to a refrigerant inlet/outlet of the one side head pipe H.

The flow passageway conduit 120 includes an insert member 121, one end of which is configured to be inserted into the receiver drier 110 through the communicating hole 110a.

A refrigerant inlet 121a and a refrigerant outlet 121b are configured to be penetrated at the insert member 212 to the other side thereof so as to communicate with the head pipe H, wherein one end portion of the insert member 212 is formed as a plate shape and is provided with a concave seating groove 121c around an end portion of the refrigerant outlet 121b.

A wing member 123 is protruded from both lateral sides of the insert member 121 in a bent shape and one side of the insert member 121 is welded to the wing member 123 so as to enclose substantially an outer circumference of the receiver drier 110.

At least one hook 125 may be formed near inner circumference of the seating groove 121c and configured to be protruded toward the seating groove 121c in a [symbol] shape.

An auxiliary wing member 127 which is protruded in a bent shape at the other side of the insert member 121 is welded to the insert member 121 so as to enclose substantially an outer circumference of the one side head pipe H.

A pair of guide bars 128 are protruded in parallel on both upper sides of the seating groove 121c, and a caulking 129 is provided to be placed on the respective guide bars 128 so as to restrain the filter fixing plate 140. In various embodiments of the present invention, the guide bars 128 may include a receiving notch 131 so that the caulking 129 may be coupled thereto.

The filter 130 is formed as a net so as to be disposed inside the receiver drier 110 to filter foreign substances contained in refrigerant, and is formed as a hat shape such that area of the net is maximized to enhance the foreign substance gathering ability.

The filter fixing plate 140 may be fixedly coupled at an edge of an end portion of the filter 130 so as to stably seat the filter 130 to the seating groove 121c of the insert member 121, and is preferably formed as a quadrilateral band shape corresponding to the hook 125 so as to be hooked to the hook 125 to be able to support the filter 130.

Hereinafter, operation of the refrigerant filtering device 100 for an air-conditioner according to various embodiments of the present invention will be explained with reference to the drawings.

The filter 130 and the flow passageway connecting conduit 120 which are coupled to one another by the filter fixing plate 140 (referring to FIG. 2) connect in a flow passageway the receiver drier 110 and the one side of the head pipe H which are disposed to face each other.

Referring to FIG. 3, the insert member 121 of the flow passageway connecting conduit 120 is disposed at an inside through the communicating hole 110a, and in addition the wing member 123 and the auxiliary wing member 127 of the flow passageway connecting conduit 120 are welded respectively to the outer circumference of the receiver drier 110 and an outer circumference of the one side of the head pipe H.

In a state of surface-contacting the outer circumference surface of the receiver drier 110 and an outer circumference of the one side of the head pipe H, the coupling of the flow passageway connecting conduit 120 is accomplished.

As such, the receiver drier 110 and the head pipe H are easily connected to one another in a flow passageway (referring to arrows shown in FIG. 3) by the flow passageway connecting conduit 120.

Furthermore, when the filter 130 is installed, the filter fixing plate 140 which is provided at an end portion thereof is hooked to the hook 125 of the receiver drier 110, and is restrained by the caulking 129, so that it can be easily installed.

The head pipe H includes a blocking member W so that refrigerant changes its flow direction to the refrigerant inlet 121a.

As mentioned above, in a refrigerant filtering device of an air-conditioner according to various embodiments of the present invention, the insert member of the flow passageway connecting conduit is disposed through the communicating hole at an inside thereof, and in addition the wing member and the auxiliary wing member are welded respectively to the outer circumference surface of the receiver drier and an outer circumference surface of the one side head pipe, so that the one side head pipe and the receiver drier are easily connected in a flow passageway.

Furthermore, when the filter is installed, the filter fixing plate which is provided at an end portion thereof is hooked to the hook and is restrained by the caulking, so that it can be easily installed.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A refrigerant filtering device of an air-conditioner, comprising:
a receiver drier having a communicating hole formed in the vicinity of a head pipe of a condenser so as to bypass refrigerant from the head pipe to the receiver drier;
an insert member configured to be inserted into the communicating hole of the receiver drier, wherein a refrigerant inlet and a refrigerant outlet are formed at the insert member so that the receiver drier communicates with the head pipe;
a wing member extending upwards in a bent shape from both lateral sides of the insert member to substantially receive the receiver drier; and
a filter which is disposed at the refrigerant outlet inside the receiver drier to filter foreign substances contained in the refrigerant.

2. The refrigerant filtering device of claim 1, wherein the filter has a hat shape.

3. The refrigerant filtering device of claim 1, wherein a filter fixing plate is attached to the filter so as to stably seat the filter to the refrigerant outlet.

4. The refrigerant filtering device of claim 3, wherein one end portion of the refrigerant outlet is formed of a concave seating groove around an inner circumference thereof and an outer circumference of the filter fixing plate is inserted into the concave seating groove.

5. The refrigerant filtering device of claim 4, wherein at least one hook is protruded from the inner circumference of the refrigerant outlet toward the seating groove so as to stably seat the filter to the refrigerant outlet.

6. The refrigerant filtering device of claim 7, wherein the hook is formed as a [symbol] shape.

7. The refrigerant filtering device of claim 3, wherein the filter fixing plate is formed as a quadrilateral band shape.

8. The refrigerant filtering device of claim 1, wherein curvature of the inner portion of the wing member is substantially the same as the curvature of the receiver drier.

9. The refrigerant filtering device of claim 1, wherein the wing member is welded to the insert member to receive an outer circumference of the receiver drier.

10. The refrigerant filtering device of claim 1, further comprises an auxiliary wing member extending downwards in a bent shape from both lateral sides of the insert member.

11. The refrigerant filtering device of claim 10, wherein curvature of the inner portion of the auxiliary wing member is substantially the same as the curvature of the head pipe.

12. The refrigerant filtering device of claim 10, wherein the auxiliary wing member is welded to the head pipe to receive an outer circumference of the head pipe.

13. The refrigerant filtering device of claim 1, further comprises a pair of guide bars which are protruded in parallel on both upper sides of the insert member.

14. The refrigerant filtering device of claim 13, wherein a caulking is configured to be placed on the respective guide bars so as to restrain the filter fixing plate.

15. The refrigerant filtering device of claim 13, wherein the guide bars includes a receiving notch and a caulking is configured to be placed on the respective notch so as to restrain the filter fixing plate.

16. An air conditioner for a vehicle comprising the refrigerant filtering device of claim 1.

17. A passenger vehicle comprising the air conditioner of claim 16.
